(19) United States
(12) Patent Application Publication
(10) Pub. No.: US 2026/0268686 A1
(43) Pub. Date: Sep. 10, 2026

(54) METHOD FOR ANALYSING A VIDEO STREAM, AND ASSOCIATED COMPUTER PROGRAM, PROCESSING DEVICE AND VEHICLE

(71) Applicant: FOGALE OPTIQUE, MONTPELLIER (FR)

(72) Inventors: Eric LEGROS, MONTPELLIER (FR); Sylvain PETITGRAND, CAISSARGUES (FR); Bruno LUONG, NIMES (FR)

(21) Appl. No.: 19/166,217

(22) PCT Filed: Mar. 21, 2023
(86) PCT No.: PCT/FR2023/050405

§ 371 Date: Sep. 17, 2025

(51) Int. Cl. G06V 20/58; G06T 7/20; G06T 7/70

(52) U.S. Cl. CPC G06V 20/58; G06T 7/20; G06T 7/70; G06T 2207/30241; G06T 2207/30252; G06V 2201/07

(57) ABSTRACT

The invention relates to a method for analyzing a 3D video stream which is representative of a scene observed through an image capture device associated with a vehicle, the method being implemented by a computer and comprising, for each image of the 3D video stream, the steps of:
for each object detected in the image, if the detected object is present in an inventory of previously detected objects:
   determining, for the image, a position and a speed of the object; and
   estimating a projected position of the object on the basis of the position and speed determined for the image, and
for each object present in the object inventory and not detected in the image: updating a projected position depending on the speed of the object that was determined for the last image in which the object was detected.

### TECHNICAL FIELD

The present invention relates to a method for analyzing a 3D video stream which is representative of a scene observed through an image capture device associated with a vehicle.

The invention also relates to a computer program, a device implementing such a method, and a vehicle comprising such a device.

The invention applies to the field of image analysis, in particular for driving assistance.

### PRIOR ART

It is known to equip a vehicle, notably a land vehicle such as a motor vehicle, with a system comprising a driving assistance device associated with an image capture device.

In such a system, the driving assistance device receives a video stream from the image capture device and adjusts the trajectory of the vehicle based on the objects detected in the scene.

However, such devices are not satisfactory.

Indeed, such a system is not able to deal with obscured objects that may appear suddenly on the trajectory of the vehicle and cause a collision.

One aim of the present invention is to overcome at least one of the shortcomings of the prior art.

### DISCLOSURE OF THE INVENTION

To this end, the invention relates to a computer-implemented analysis method of the aforementioned type and comprising, for each image of the 3D video stream, the steps of:
for each object detected in the image, whether said detected object is present in an object inventory of previously detected objects:
   determining, for said image, a position and a speed of the object; and
   estimating a projected position of the object from the position and the speed determined for said image, and
for each object present in the object inventory and not detected in the image, updating a corresponding projected position based on the speed of said object which was determined for the last image in which the object was detected.

Indeed, by virtue of estimating a projected position for each object that has been detected in the past, it is possible to predict a plausible trajectory for obscured objects.

Such projected positions, when transmitted to a driving assistance device, can be taken into account to calculate safer trajectories and reduce the risk of collisions.

Advantageously, the method according to the invention has one or more of the following features, taken in isolation or according to any technically possible combination:

the method further comprises, for each image and for each object detected in the image and absent from the object inventory, the steps of:
creating, in the object inventory, a new object corresponding to said detected object; and
determining, for said image, a position of the detected object;

the method comprises, for each object present in the object inventory and not detected in a current image of the 3D video stream, deleting said object from the object inventory if the object has not been detected in a predetermined number of previous consecutive images of the 3D video stream and/or if an estimated probability of a new encounter with the object is less than a predetermined floor value;

for each image of the 3D video stream, each pixel is associated with a feature of the corresponding point in the scene, a set of related pixels, for which a difference of the feature with respect to neighboring pixels is greater than a predetermined threshold, forming a detected object, and for each pixel, said feature being the distance with respect to the image capture device of the point in the scene corresponding to said pixel, and/or the color of said point and/or the speed;

the method further comprises determining that an object detected in a current image of the 3D video stream is present in the object inventory if a difference between a position of the detected object and a current projected position of an object in the object inventory is less than a predetermined deviation;

each object in the object inventory is associated with a corresponding representation, the method comprising determining that an object detected in a current image of the 3D video stream is present in the object inventory if the part of the current image corresponding to the detected object has a similarity greater than a predetermined threshold with at least a part of the representation corresponding to an object in the object inventory;

each object in the object inventory is associated with a corresponding representation, the method comprising, for each image of the 3D video stream, and for each detected object present in the object inventory, the steps of:
comparing the part of the image representative of said detected object with the corresponding representation in the object inventory to determine whether at least a portion of said part of the image is absent from the representation; and
enriching the representation with said at least one portion;

for each object in the object inventory, the corresponding representation comprises a set of pixels, each pixel being associated with a relative position in a predetermined reference frame, the relative positions of the pixels of a same object being representative of the relative positions of the corresponding points in the scene;

the method comprises, for each image wherein, in a plane of a detector of the image capture device, a part of a first detected object is circumscribed within a part of a second detected object, the first object being located at a distance from the image capture device greater than a distance from the second detected object, assigning an attribute whereby the first object is a potential reflection;

the method further comprises, for each first object present in the object inventory, the steps of:
comparing a position of the first object with the corresponding current projected position; and
based on the result of the comparison, assigning to the attribute a first value, whereby the first object is a reflection, or a second value, whereby the first object is a real object;

the method further comprises, for each first object present in the object inventory, the steps of:
determining a position of a duplicate of the first object, such that the first object and the duplicate thereof are symmetrical to each other with respect to the second object; and
determining a speed and a projected position of the duplicate;

the method further comprises, for each image of the 3D video stream, information associated with at least one pixel and indicative of the fact that:
the point in the scene corresponding to said pixel was observed by a single camera of the image capture device;
the pixel has been extrapolated; and/or
the pixel is saturated;

the method further comprises, for each image of the 3D video stream, and for each object detected in the image:
calculating a margin of error on the position and/or the speed of the object determined for said image; and/or
calculating a margin of error on the projected position of the object estimated for said image.

According to another aspect of the invention, a computer program is provided comprising executable instructions, which, when they are executed by a computer, implement the steps of the method as defined hereinbefore.

The computer program can be in any computer language, such as, for example, in machine language, in C, C++, JAVA, Python, etc.

According to another aspect of the invention, a processing device is proposed for analyzing a 3D video stream representative of a scene observed through an image capture device associated with a vehicle, the processing device being configured so as to, for each image of the 3D video stream:
for each object detected in the image, whether said detected object is present in an inventory of previously detected objects:
   determining, for said image, a position and a speed of the object; and
   estimating a projected position of the object from the position and from the speed determined for said image, and
for each object present in the object inventory and not detected in the image, updating a corresponding projected position based on the speed of said object which was determined for the last image in which the object was detected.

The device according to the invention can be any type of apparatus such as a server, a computer, a tablet, a calculator, a processor, a computer chip, programmed to implement the method according to the invention, for example by running the computer program according to the invention.

According to another aspect of the present invention, a vehicle is proposed comprising an image capture device and a processing device as defined hereinbefore, the image capture device being configured to acquire a 3D video stream representative of a scene, and to transmit the acquired 3D video stream to the processing device.

According to some embodiments, the vehicle is a land vehicle, whether autonomous or not, for example a car.

According to some embodiments, the vehicle is a flying vehicle, whether autonomous or not, for example a drone, an airplane or a helicopter.

According to some embodiments, the vehicle is a marine vehicle, whether autonomous or not, such as a boat or submarine.

Preferably, the vehicle further comprises a driving assistance device configured to calculate a target trajectory for the vehicle based on a position, a speed and/or a projected position of at least one object present in the object inventory.

The invention also relates to a use of the analysis method as defined hereinbefore, or of the processing device as defined hereinbefore, in such a vehicle, for analyzing a 3D video stream representative of a scene observed through the image capture device of the vehicle.

### BRIEF DESCRIPTION OF THE FIGURES

The invention will be better understood from reading the following description, which is given solely by way of non-limiting example and with reference to the accompanying drawings whereupon:

FIG. 1 is a schematic depiction of a vehicle according to the invention;

FIG. 2 is a flowchart of the analysis method according to the invention;

FIGS. 3A to 3C are schematic depictions showing the implementation of the method shown in FIG. 2, with a detected object becoming completely obscured;

FIGS. 4A to 4C are schematic depictions showing the implementation of the method shown in FIG. 2, with a detected object becoming partially obscured; and

FIGS. 5A and 5B are schematic depictions showing, respectively, a situation where a detected object is a reflection, and a situation where a detected object is seen through another object.

It is clearly understood that the embodiments that will be described hereafter are by no means limiting. In particular, it is possible to imagine variants of the invention that comprise only a selection of the features disclosed hereinafter in isolation from the other features disclosed, if this selection of features is sufficient to confer a technical benefit or to differentiate the invention with respect to the prior art. This selection comprises at least one preferably functional feature which is free of structural details, or only has a part of the structural details if this part alone is sufficient to confer a technical benefit or to differentiate the invention with respect to the prior art.

In particular, all of the described variants and embodiments can be combined with each other if there is no technical obstacle to this combination.

In the figures and in the remainder of the description, the same reference has been used for the features that are common to several figures.

### DETAILED DESCRIPTION

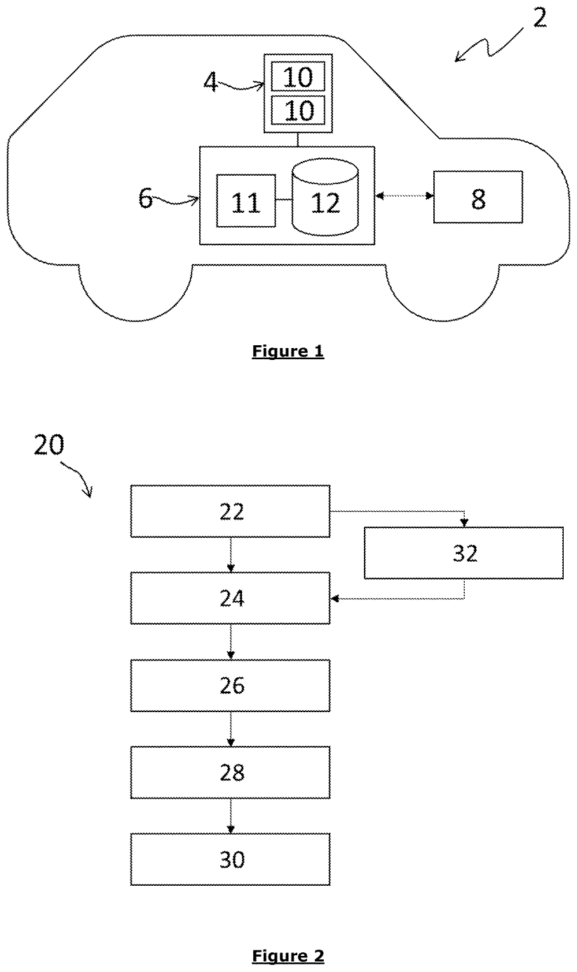

A vehicle 2 according to the invention is shown by FIG. 1.

The vehicle 2 carries an image capture device 4 and a processing device 6 which are connected therebetween.

The image capture device 4 is configured to acquire a 3D video stream representative of an observed scene, in particular a scene wherein the vehicle 2 is moving. The image capture device 4 is further configured to transmit the acquired 3D video stream to the processing device 6.

The processing device 6 is configured to process the 3D video stream, and notably to detect the objects in the scene and to analyze their respective trajectories.

Preferably, the vehicle 2 is further fitted with a driving assistance device 8 for the vehicle 2. In this case, the driving assistance device 8 is configured to assist the driving of the vehicle 2, for example by determining target trajectories for the vehicle 2, notably avoidance trajectories to avoid collisions with objects detected in the scene, whether moving or not.

More precisely, the driving assistance device 8 is configured to calculate a target trajectory for the vehicle 2 based on a position, a speed and/or a projected position of at least one object present in an object inventory 12, described later.

As previously mentioned, the image capture device 4 is configured to acquire a 3D video stream which is representative of the observed scene.

In particular, in each image, referred to as a “3D image”, of the 3D video stream delivered by the image capture device 4, each pixel is associated with a point in the scene.

The image capture device 4 comprises, for example, at least two cameras 10. In this case, each camera 10 is arranged at a respective predetermined position with respect to the vehicle 2.

Preferably, an optical axis of each camera 10 has a known respective orientation in a predetermined reference frame, in particular in the reference frame of the vehicle 2.

As a result, for each pixel of each 3D image, a position of the corresponding point in the scene in a predetermined three-dimensional reference frame can be extracted.

Alternatively, the image capture device 4 comprises at least one camera 10 associated with at least one telemetry device (such as a LiDAR) configured to provide depth information, that is, information relating to the distance between the camera 10 and each point in the scene observed by said camera 10. In this case, the image capture device 4 is configured to merge the information from the telemetry unit with the images from the at least one camera 10 to generate each 3D image. Consequently, in this case too, for each pixel of each 3D image, a position of the corresponding point in the scene in the predetermined three-dimensional reference frame can be extracted.

More precisely, in each 3D image, each pixel is associated with at least one predetermined feature of the corresponding point in the scene. For example, for a given pixel, the at least one predetermined feature comprises:
the distance between the point in the scene corresponding to said pixel and the image capture device 4; and/or
the color of the point in the scene corresponding to said pixel.

Optionally, the predetermined feature associated with a given pixel of the 3D image comprises the speed, in a predetermined reference frame, of the point in the scene corresponding to said pixel. This is the case, for example, when the image capture device 4 is configured to track each point in the scene, image by image, in order to determine speed information.

Preferably, the image capture device 4 is also configured to associate, with each pixel of each 3D image, information relating to the camera 10 (respectively, the cameras 10) which observed the corresponding point in the scene.

Preferably still, the image capture device 4 is also configured to associate, with each saturated pixel of each 3D image, information as to whether said pixel is saturated. For the purposes of the present invention, “saturated pixel” means a pixel whose corresponding photodetector in the image capture device 4 is saturated.

Preferably, the image capture device 4 is also configured to associate, with each pixel of each 3D image, information as to whether or not said pixel has been extrapolated.

As previously stated, the processing device 6 is configured to process the 3D video stream from the image capture device 4.

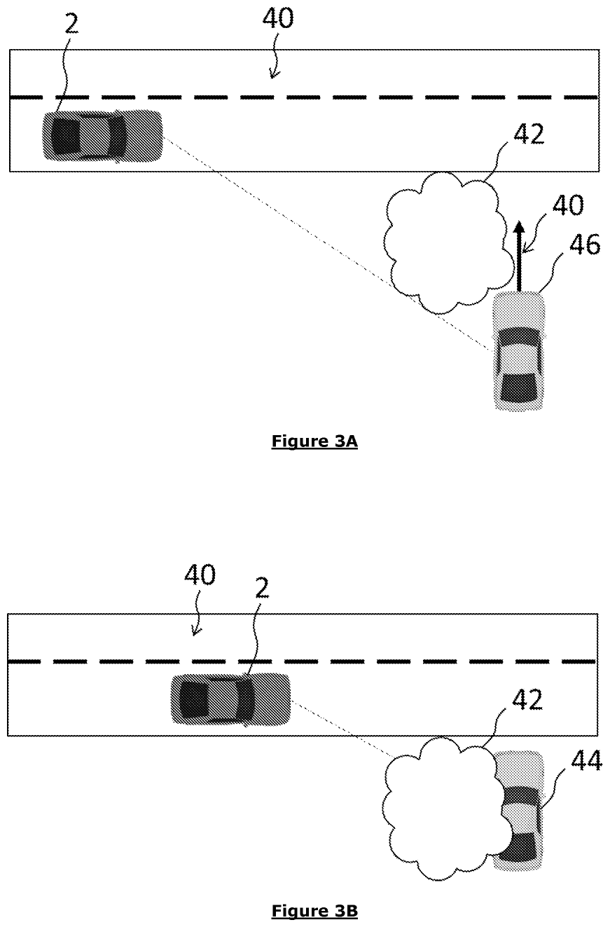

More precisely, the processing device 6 is configured to implement an analysis method 20 (FIG. 2) comprising, for each 3D image taken from the 3D video stream, an object detection step 22, an identification step 24, a kinematic calculation step 26 and a projected position estimation step 28.

The processing device 6 is also configured to implement, for each 3D image, a step 30 of managing the object inventory 12.

Advantageously, the processing device 6 is also configured to implement a step 32 of managing reflections.

### Object Detection 22

The processing device 6 is configured to detect the objects present in said 3D image during the object detection step 22 for each 3D image.

For example, to detect each object in the scene, the processing device 6 is configured to implement an artificial intelligence model. Such an artificial intelligence model has, for example, been previously trained to recognize a set of predetermined objects (for example vehicles, pedestrians, cyclists, strollers, buildings, street furniture, vegetation, etc.) according to their appearance.

Alternatively, or additionally, the processing device 6 is configured to detect each object from an analysis of the pixels in each 3D image.

More precisely, for each 3D image, the processing device 6 is configured to detect each object in the scene as being a set of related pixels for which a difference in the or each aforementioned predetermined feature, with respect to neighboring pixels, is greater than a predetermined threshold.

This is advantageous in that such a feature allows objects in the observed scene to be detected on the basis of a simple jump in value (also known as “shearing”) of the predetermined feature, and without the need to implement complex segmentation and/or pattern recognition algorithms.

Alternatively, or additionally, the processing device 6 is configured to detect each object based on the implementation of a Sobel filter comprising edge detection.

### Identification 24

The processing device 6 is also configured to keep an object inventory 12 up to date. In particular, the object inventory 12 stores each detected object. More specifically, each detected object is associated, in the object inventory 12, with a respective unique identifier.

Additionally, for each object detected, the processing device 6 is configured to write corresponding information to the object inventory 12.

Preferably, for each object detected, said information stored in the object inventory 12 comprises a representation associated with said object.

Advantageously, for each object detected, the corresponding representation comprises a set of pixels, each of which is, in particular, associated with a relative position in a predetermined reference frame. In this case, for the same object detected in the scene, the relative positions stored for the pixels of the associated representation are representative of the relative positions of the corresponding points of the object in the scene.

Further information about the objects detected and stored in the object inventory 12 will become apparent from the following description.

To keep the object inventory 12 up to date, the processing device 6 is configured to determine, for each 3D image, and for each object detected in said 3D image, whether or not said detected object is present in the object inventory 12.

Preferably, the processing device 6 is configured to determine that an object detected in a current 3D image is present in object inventory 12 (that is, that it has been detected in at least one previous 3D image) if a difference between the position of the detected object and a current projected position of an object in object inventory 12 is less than a predetermined deviation.

Such a current projected position, representative of an expected position for a previously detected object, will be described later.

This feature is advantageous in that it allows previously detected objects to be recognized on the basis of their expected position, without requiring the implementation of complex pattern recognition algorithms.

Alternatively, or additionally, the processing device 6 is configured to determine that an object detected in a current 3D image is present in the object inventory 12 if the part of the current 3D image corresponding to the detected object (or at least a fraction of this part) has a similarity (with respect to a predetermined similarity index, such as a correlation) greater than a predetermined threshold with at least a part of the representation corresponding to an object in the object inventory 12.

This feature is advantageous in that it allows a previously detected object of interest to be tracked even if it is partially obscured, for example by another object in the scene, interposed between the image capture device 4 and said object of interest.

Advantageously, for each detected object, the processing device 6 is configured to compare the part of the 3D image that is representative of said detected object with the corresponding representation stored in the object inventory 12, in order to determine whether at least a portion of said part of the 3D image is absent from said representation.

In this case, the processing device 6 is configured to enrich the representation with said at least one portion, that is, to complete the object representation with the new data provided by the current 3D image.

This is advantageous, insofar as such a feature leads to the construction of a potentially complete representation of the detected object, likely to be used by the driving assistance device 8, or even to be used in virtual reality software.

### Kinematic Calculation 26

If the detected object is present in the object inventory 12, for the current 3D image and for said detected object, the processing device 6 is configured to determine a corresponding position and speed, notably in the predetermined reference frame.

For example, the processing device 6 is configured to directly extract the position of the detected object, or of each part of the detected object, from the distance data associated with each pixel of the 3D image corresponding to said detected object.

For example, the processing device 6 is configured to determine the speed of the object from the current position and from the previous position of the object, that is, the position of the object on the last 3D image wherein said object was detected.

Preferably, the processing device 6 is configured to write, in the object inventory 12, for said object, and for said 3D image, the corresponding determined position(s) and/or speed(s).

Advantageously, for each 3D image, and for each object detected, the processing device 6 is also configured to determine an acceleration of said object.

For example, the processing device 6 is configured to determine the acceleration of the object from the current position and from the last two positions determined for said object, that is, the position of the object on the last and the penultimate 3D images wherein said object was detected.

In this case, the processing device 6 is also configured to write, in the object inventory 12, for said object, and for the current 3D image, the corresponding determined acceleration.

Preferably, in the case where, for all or some of the pixels of a given 3D image, the corresponding point in the scene has been observed by a single camera 10, the processing device 6 is also configured to calculate a margin of error on the determined position(s) and/or the speed(s) of the object.

Such a feature is advantageous in that it takes into account the fact that depth (that is, the distance with respect to the image capture device 4) is generally poorly estimated for points in the scene observed by means of a single camera, which is likely to lead to a poor estimate of the actual volume of each object and therefore, by extension, of its position and/or of its speed.

Similarly, in the event that, for a given 3D image, all or some of the pixels associated with an object have been extrapolated and/or are saturated, the processing device 6 is also configured to calculate, as a result, a margin of error on the determined position(s) and/or speed(s) of the object.

Such a feature is advantageous in that it allows for a risk of extrapolation error or insufficient detection quality to be taken into account (for example due to a risk of obscuring part of the object because of the saturation effect).

In this case, the processing device 6 is also configured to write, in the object inventory 12, for said object, and for the current 3D image, the corresponding margin of error on the position and/or the speed that has been calculated.

### Projected Position Estimate 28

Additionally, the processing device 6 is configured to estimate the projected position of the detected object, as mentioned previously.

For the purposes of the present invention, “projected position” means the most plausible future position for the detected object, at a time later than a current time associated with the current 3D image, based on the knowledge of at least part of its trajectory up to the current time.

In particular, for a given object that is detected in the current 3D image, the projected position is representative of the expected position for said object at the time associated with the next 3D image in the 3D video stream.

More precisely, the processing device 6 is configured to estimate the projected position of the object from the position and from the speed determined for the current 3D image.

Advantageously, in the event that the acceleration of the detected object has been determined during the kinematic calculation step 26, the processing device 6 is configured to also estimate the projected position of the object from the determined acceleration.

Preferably, the processing device 6 is configured to write, in the object inventory 12, for said object, and for said 3D image, the corresponding estimated projected position.

Preferably, the processing device 6 is also configured to calculate a margin of error on the estimated projected position of a given object. In particular, the processing device 6 is configured to calculate said margin of error on the estimated projected position if the position and/or the speed of said object determined in the kinematic calculation step 26 is (are) associated with a corresponding margin of error. In this case, the margin of error on the estimated projected position preferably depends on the margin of error associated with the position and/or the speed.

Alternatively, or additionally, the processing device 6 is configured to calculate a margin of error on the estimated projected position of a given object if, for all or some of the pixels associated with said object, it has been previously determined that:
the corresponding point in the scene was observed by a single camera 10;
said associated pixels have been extrapolated; and/or
said pixels are saturated.

Calculating a margin of error on the estimated projected position is advantageous, insofar as it is likely to cause the driving assistance device 8 to control the vehicle 2 with improved safety conditions.

In this case, the processing device 6 is preferably also configured to write, in the object inventory 12, for said object, and for said 3D image, the calculated margin of error on the corresponding estimated projected position.

### Object Inventory Management 30

For each object present in the object inventory 12 and not detected in the current 3D image, the processing device 6 is configured to update the corresponding projected position during the management step 30.

In particular, for each 3D image, and for each object present in the inventory 12 but not detected in said 3D image, the processing device 6 is configured to update the corresponding projected position based on the speed of said object which was determined for the last 3D image in which the object was detected.

This is advantageous, as such an update facilitates subsequent identification of the object, based on a difference between the corresponding projected position, which is calculated iteratively for 3D images wherein said object is not detected, and the actual position of the object when it is detected again.

Advantageously, in the case where the acceleration of the undetected object has been previously determined, the processing device 6 is configured to update the projected position of said undetected object, also on the basis of the determined acceleration.

Advantageously, if a given object present in the object inventory 12 has not been detected in the current 3D image, as well as in a predetermined number of consecutive 3D images immediately preceding it, the processing device 6 is configured to remove said object from the object inventory 12.

Alternatively, or additionally, if the estimate of a series of projected positions of a given object present in the object inventory 12 makes it highly unlikely that said object will be encountered by the vehicle 2 (that is, the probability of such an encounter is less than a predetermined floor value), the processing device 6 is configured to remove said object from the object inventory 12.

This feature is advantageous in that it prevents uncontrolled growth in the memory space occupied by the object inventory 12. This would, for example, be likely to occur in a situation where the vehicle 2 is on a road and encounters numerous vehicles moving in an opposite direction: the vehicles encountered are unlikely to be crossed again.

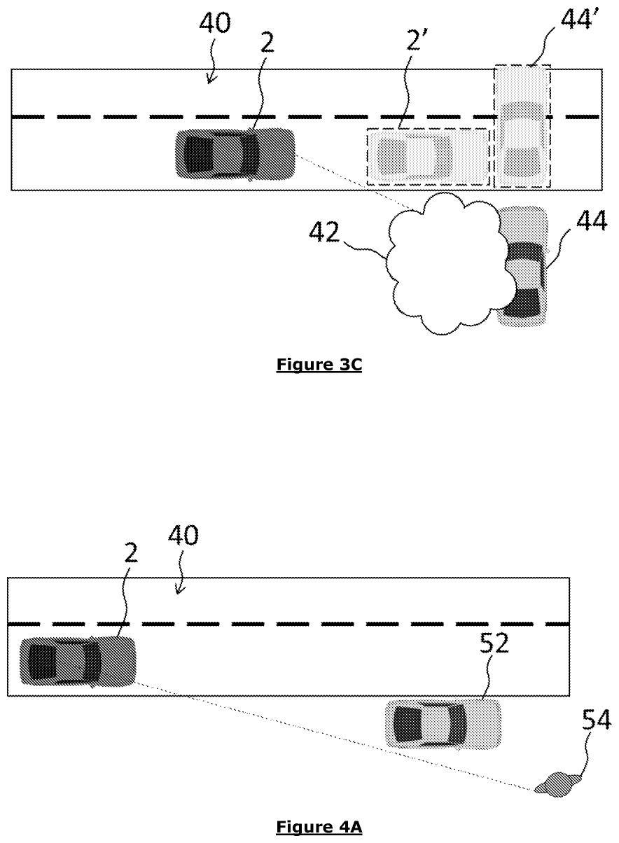

By virtue of the implementation of steps 22 to 30, collisions with objects that are no longer visible are easier to avoid, as will become apparent from the example shown in FIGS. 3A to 3C.

As shown in FIG. 3A, the vehicle 2 is traveling on a road 40. The processing device 6 detects a copse 42 and a third vehicle 44 from the 3D video stream received from the image capture device 4. Additionally, the processing device 6 determines the position and the speed (shown by the arrow 46) of the third vehicle 44.

At a later time, as shown in FIG. 3B, the third vehicle 44 is completely screened by the copse 46, and is no longer visible from the vehicle 2.

By virtue of the implementation of the method 20, the projected position of the third vehicle 44 is determined from, notably its speed 46 when it was still visible, which allows the driving assistance device 8 to anticipate a future collision between the third vehicle (referenced 44′) and the vehicle (referenced 2′), shown in FIG. 3C.

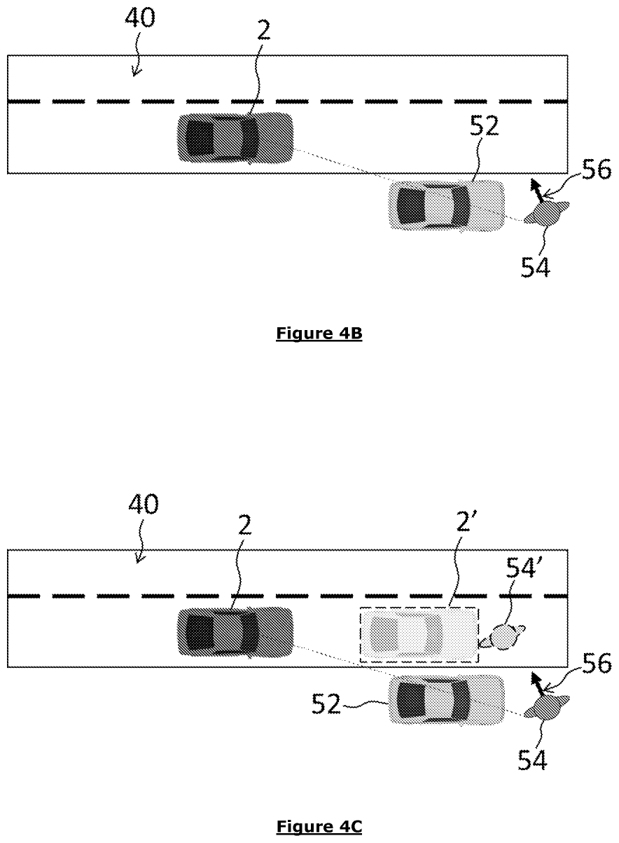

Additionally, by virtue of the implementation of steps 22 to 30, collisions with objects that are only partially visible are also easier to avoid, as will become apparent from the example in FIGS. 4A to 4C.

As shown in FIG. 3A, the vehicle 2 is traveling along the road 40. The processing device 6 detects a parked vehicle 52 and a pedestrian 54 from the 3D video stream received from the image capture device 4.

At a later time, as shown in FIG. 4B, the pedestrian 54 is partially screened by the parked vehicle 56, so that part of the pedestrian is no longer visible from the vehicle 2.

When the processing device 6 is configured to determine that an object detected in a current 3D image is present in the object inventory 12 if a part of the current 3D image corresponding to the detected object has a similarity with at least a part of the representation corresponding to an object in the object inventory 12, the processing device 6 is able to track the pedestrian 54 even in the situation of FIG. 4B.

In particular, the processing device 6 determines the position and the speed (arrow 56) of the pedestrian 54, even though he is only partially visible.

By virtue of the implementation of the method 20, the projected position of the pedestrian 54 is determined from, notably his speed 56, which allows the driving assistance device 8 to anticipate a future collision between the vehicle (referenced 2′) and the pedestrian (referenced 54′), shown in FIG. 4C.

### Reflection Management 32

As previously indicated, the processing device 6 is advantageously configured to also implement a reflection management step 32.

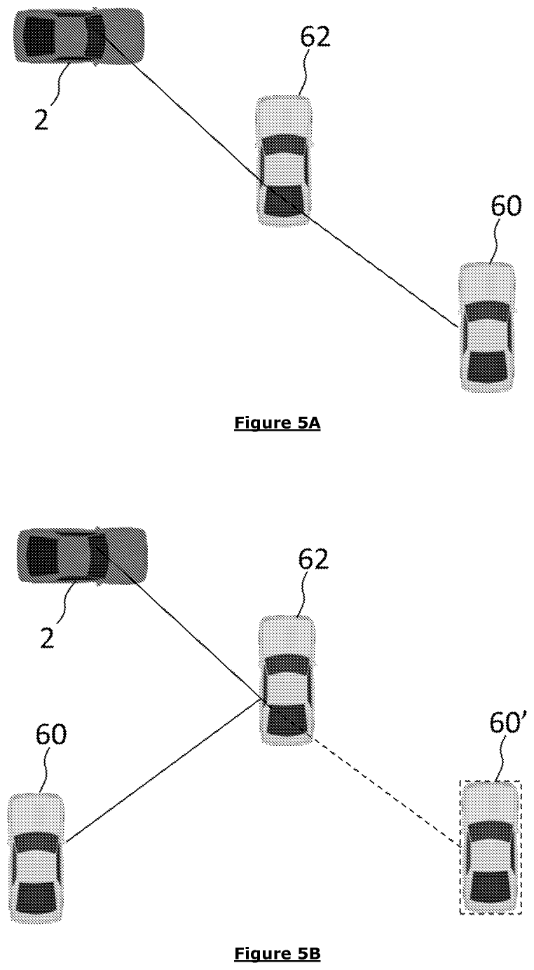

For example, in the example of FIG. 5A, from the vehicle 2, the first vehicle 60 is seen through a window of the second vehicle 62.

In this case, in the scene projected onto the sensors of the image capture device 4 of the vehicle 2, a part of the body of the second vehicle 62 surrounds a part of the first vehicle 60.

In FIG. 5B, from vehicle 2, the first vehicle 60 is seen reflected on the window of the second vehicle 62.

Nevertheless, the scene projected onto the sensors of the image capture device 4 is identical to that shown in FIG. 5A.

In the situations shown in FIGS. 5A and 5B, there is uncertainty as to whether it is the first object 60 itself or its reflection 60′ that is observed.

In this case, for a given 3D image, if the processing device 6 determines, in the object detection step 22, that, in a plane of a detector of the image capture device 4, a part of a first detected object is circumscribed within a part of a second detected object, the first object being located at a distance from the image capture device 4 greater than a distance from the second detected object, then the processing device 6 is configured to assign an attribute whereby the first detected object is a potential reflection.

Advantageously, for each first object (that is, a detected object that is a potential reflection), the processing device 6 is configured to compare a position of the first object with the corresponding current projected position, if said first object has been previously detected.

Additionally, for each first object, the processing device 6 is configured to assign to the attribute, based on a result of the comparison, a first value, whereby the first object is a reflection, or a second value, whereby the first object is a real object.

If the first object has not been previously detected, that is, if it is not present in the object inventory 12, the processing device 6 cannot carry out such a comparison.

In this case, the processing device 6 is configured to calculate the position of a duplicate of the first object, such that the first object and its duplicate are symmetrical to each other with respect to the second object.

For example, in FIG. 5B, the first object is the virtual image 60′, and the duplicate, whose position is calculated by the processing device 6, is the real object 60.

Furthermore, in this case, the processing device 6 is configured to determine the position, the speed and the projected position of not only the first object, but also of its duplicate, when performing the kinematic calculation 26 and the projected position estimation 28 steps for subsequent 3D images, preferably until it is determined which of the first object and its duplicate is the object actually present in the scene.

### Operation

The operation of the processing device 6 will now be described with reference to FIG. 2.

The image capture device 4 acquires a 3D video stream representative of the scene observed and transmits it to the processing device 6.

During the object detection step 22, for each 3D image in the 3D video stream, the processing device 6 detects the objects present in said 3D image.

Then, during the identification step 24, the processing device 6 determines, for each 3D image, and for each object detected in said 3D image, whether or not said detected object is present in the object inventory 12.

Then, if the detected object is present in the object inventory 12, then, for the current 3D image and for said detected object, the processing device 6 determines, during the kinematic calculation step 26, a corresponding position and a speed, notably in the predetermined reference frame.

Then, in the projected position estimation step 28, the processing device 6 estimates the projected position of the detected object.

Then, in the object inventory management step 30, for each object present in the object inventory 12 and not detected in the current 3D image, the processing device 6 updates the corresponding projected position.

Optionally, in step 32, the processing device 6 processes potential reflections.

Of course, the invention is not limited to the examples disclosed above.

1. A method for analyzing a 3D video stream representative of a scene observed through an image capture device associated with a vehicle, the method being implemented by a computer and comprising, for each image of the 3D video stream, the steps of:
for each object detected in the image, if said detected object is present in an object inventory of previously detected objects:
determining, for said image, a position and a speed of the object; and
estimating a projected position of the object from the position and the speed determined for said image, and
for each object present in the object inventory and not detected in the image, updating a corresponding projected position based on the speed of said object which was determined for the last image in which the object was detected.

2. The method according to claim 1, further comprising, for each image and for each object detected in the image and absent from the object inventory, the steps of:
creating, in the object inventory, a new object corresponding to said detected object; and
determining, for said image, a position of the detected object.

3. The method according to claim 1, or comprising, for each object present in the object inventory and not detected in a current image of the 3D video stream, deleting said object from the object inventory if the object has not been detected in a predetermined number of previous consecutive images of the 3D video stream and/or if an estimated probability of a new encounter with the object is less than a predetermined floor value.

4. The method according to claim 1, wherein for each image of the 3D video stream, each pixel is associated with a feature of the corresponding point in the scene,
wherein a set of related pixels, for which a difference of the feature with respect to neighboring pixels is greater than a predetermined threshold, forms a detected object, and
for each pixel, said feature being the distance with respect to the image capture device of the point in the scene corresponding to said pixel, and/or the color of said point and/or the speed.

5. The method according to claim 1, further comprising determining that an object detected in a current image of the 3D video stream is present in the object inventory if a difference between a position of the detected object and a current projected position of an object in the object inventory is less than a predetermined deviation.

6. The method according to claim 1, wherein each object in the object inventory is associated with a corresponding representation,
the method comprising determining that an object detected in a current image of the 3D video stream is present in the object inventory if the part of the current image corresponding to the detected object has a similarity greater than a predetermined threshold with at least a part of the representation corresponding to an object in the object inventory.

7. The method according to claim 1, wherein each object in the object inventory is associated with a corresponding representation,
the method comprising, for each image of the 3D video stream, and for each detected object present in the object inventory, the steps of:
comparing the part of the image representative of said detected object with the corresponding representation in the object inventory to determine whether at least a portion of said part of the image is absent from the representation; and
enriching the representation with said at least one portion.

8. The method according to claim 6, wherein, for each object in the object inventory, the corresponding representation comprises a set of pixels, each pixel being associated with a relative position in a predetermined reference frame, the relative positions of the pixels of a same object being representative of the relative positions of the corresponding points in the scene.

9. The method according to claim 1, comprising, for each image wherein, in a plane of a detector of the image capture device, a part of a first detected object is circumscribed within a part of a second detected object, the first object being located at a distance from the image capture device greater than a distance from the second detected object, assigning an attribute whereby the first object is a potential reflection.

10. The method according to claim 9, further comprising, for each first object present in the object inventory, the steps of:
comparing a position of the first object with the corresponding current projected position; and
based on the result of the comparison, assigning to the attribute a first value, whereby the first object is a reflection, or a second value, whereby the first object is a real object.

11. The method according to claim 10, further comprising, for each first object present in the object inventory, the steps of:
determining a position of a duplicate of the first object, such that the first object and the duplicate thereof are symmetrical to each other with respect to the second object; and
determining a speed and a projected position of the duplicate.

12. The method according to claim 1, further comprising, for each image of the 3D video stream, information associated with at least one pixel and indicative of the fact that:
the point in the scene corresponding to said pixel has been observed by a single camera of the image capture device;
the pixel has been extrapolated; and/or
the pixel is saturated.

13. The method according to claim 1, further comprising, for each image of the 3D video stream, and for each object detected in the image:
calculating a margin of error on the position and/or the speed of the object determined for said image; and/or
calculating a margin of error on the projected position of the object estimated for said image.

14. A computer program comprising executable instructions which, when they are executed by a computer, implement the steps of the method according to claim 1.

15. A processing device for analyzing a 3D video stream which is representative of a scene observed through an image capture device associated with a vehicle, the processing device being configured so as to, for each image of the 3D video stream:
for each object detected in the image, whether said detected object is present in an object inventory of previously detected objects:
determining, for said image, a position and a speed of the object; and
estimating a projected position of the object from the position and from the speed determined for said image, and
for each object present in the object inventory and not detected in the image, updating a corresponding projected position based on the speed of said object which was determined for the last image wherein the object was detected.

16. A vehicle comprising an image capture device and a processing device according to claim 15, the image capture device being configured to acquire a 3D video stream representative of a scene, and to transmit the acquired 3D video stream to the processing device.

17. The vehicle according to claim 16, further comprising a driving assistance device configured to calculate a target trajectory of the vehicle based on a position, a speed and/or a projected position of at least one object present in the object inventory.

18. Use of an analysis method according to claim 1, for the analysis of a 3D video stream which is representative of a scene observed through the image capture device of a vehicle.

19. Use of a processing device according to claim 15, for the analysis of a 3D video stream which is representative of a scene observed through the image capture device of a vehicle.
